(19) United States
(12) Patent Application Publication
(10) Pub. No.: US 2003/0225954 A1
(43) Pub. Date: Dec. 4, 2003

(54) USB hub

(76) Inventor: Chin Chao Wu, Taipei (TW)

Correspondence Address: RABIN & BERDO, P.C., Suite 500, 1101 14th Street, N.W., Washington, DC, 20005, US

(21) Appl. No.: 10/157,829

(22) Filed: May 31, 2002

(51) Int. Cl. G06F 13/14

(52) U.S. Cl. 710/305

(57) ABSTRACT

A USB (Universal Serial Bus) Hub is comprised of a device for showing the transmission rate of data therein, and the obtained result of the device can be shown via a lamp signal. By virtue of this device, enable users to judge if the peripheral devices connected by a hub in series and the transmission speed of data between host computers are matching suitably, and a peripheral device with the same transmission rate can be replaced so as to prevent a jam from being occurred during data transmission.

### BACKGROUND OF THE INVENTION

This invention relates generally to a Hub, and more particularly to a Hub enabling users to judge if the peripheral devices connected by a hub in series and the transmission rate of data between host computers are matching suitably, and a peripheral device with the same transmission rate can be replaced so as to prevent a jam from being occurred during data transmission.

People run a race with time all the time. The acme of speed is what the scientists devote their lifetime to seek and dream. To be on a time with rising and flourishing technology, various opinions to speed are came into existence in accordance with the time and the place. As computers are now in widespread use, the speeds of process and operation are scaled new heights as well as advancement technology of a microprocessor. In recent years, the USB has came into being as an interface for easily connecting a plurality of peripheral devices to a personal computer and now attracts much attention. However, peripheral devices having a port for USB are limited from a host computer. Therefore, it is necessary for the user to purchase a USB hub for joining peripheral devices so that expand the use. Please refer to FIG. 1 shown a conventional configuration of a USB hub.

As shown in FIG. 1, a USB hub 1 is comprising a USB port 11 connected to a host computer, four USB ports 12 which can be expanded outwardly and disposed to connect with peripheral devices, four light-emitting units 13 disposed respectively to each of four USB ports 12, and a power supply port 14 for supplying power to the USB hub 1 for operation. By this arrangement, a host computer can be connected to the USB port 11 of the USB hub 1 via buses and a lack of USB originally can be expanded for connecting other peripheral devices to the host computer. After other peripheral devices are inserted to the USB ports 12, the light-emitting units 13 opposite to the USB ports 12 are then shined and it means that a connection is completed.

However, we do not know if the peripheral devices connected by a hub in series and the transmission rate of data between the host computers are suitably matching with a transmission speed of data therebetween. If the transmission speed to the host computer is slower than peripheral devices thereto, it means that peripheral devices would not be brought its performance into full play and this result a waste of operation resource. But if the transmission speed to the host computer is faster than peripheral devices thereto, a jam will be occurred during data transmission.

It is therefore tried by the inventor to develop a USB hub, especially a Hub having a device for showing the transmission rate of data therein, and the obtained result of the device can be shown via a lamp signal. By virtue of this device, enable users to judge if the peripheral devices connected by a hub in series and the transmission speed of data between host computers are matching suitably, and a peripheral device with the same transmission rate can be replaced so as to prevent a jam from being occurred during data transmission.

### SUMMARY OF THE INVENTION

Accordingly, it is a primary object of the present invention claimed herein to provide a USB hub, which is enable users to judge if the peripheral devices connected by a hub in series and the transmission speed of data between host computers are matching suitably, and a peripheral device with the same transmission rate can be replaced so as to prevent a jam from being occurred during data transmission.

For reaching above object, the invention is a Hub having a device for showing the transmission rate of data, and the obtained result of the device can be shown via a lamp signal. By virtue of this arrangement, enable users to judge if the peripheral devices connected by a hub in series and the transmission speed of data between host computers are matching suitably, and a peripheral device with the same transmission rate can be replaced so as to prevent a jam from being occurred during data transmission.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a conventional configuration of a USB hub;

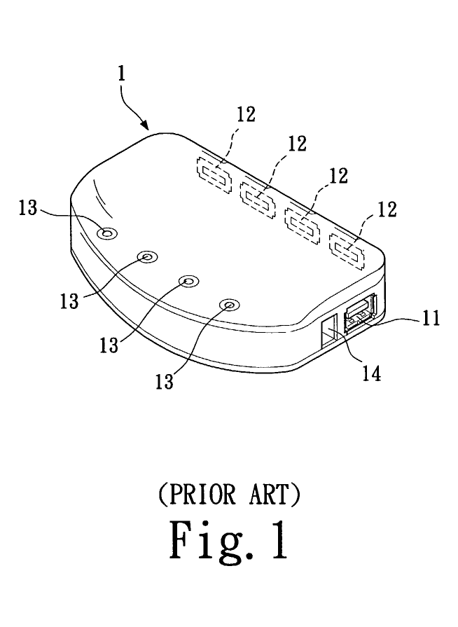

FIG. 2 is an exploded view illustrating a USB hub according to the present invention;

FIG. 3 is an assembled side view illustrating a USB hub according to the present invention.

### DETAILED DESCRIPTION OF THE PREFERRED EMBODIMENTS

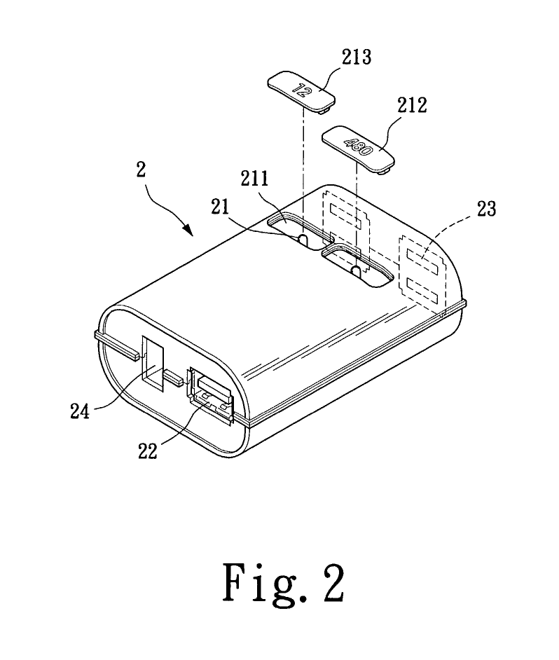

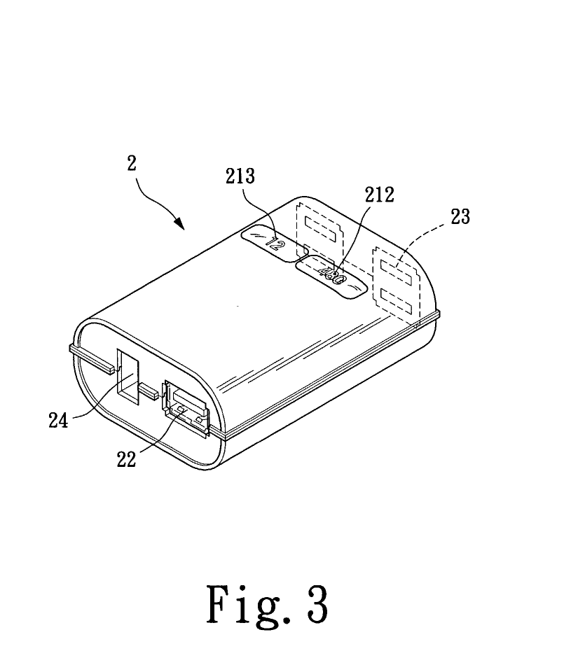

Referring now to FIG. 2 and FIG. 3 that shows an exploded view and an assembled side view of a USB hub according to the present invention respectively. As shown, in the inner part of a USB hub 2, a device disposed for showing a transmission rate of data and two light-emitting units (LED, Light Emitting Diode) 21 for showing the obtained result are provided. In the outer part of the USB hub 2, a USB port 22 connected with a host computer, four USB ports 22 expanded outwardly and disposed for connecting to peripheral devices, and a power supply port 24 supply power to the USB hub 2 for operation are provided respectively. Further, a through hole 211 is disposed at a position that a housing of the USB hub 2 is corresponding to the light-emitting units 21 in order to show various lamp signal where the data transmission rate of the USB hub 2 is 480 (within the USB 2.0 data transmission of 480 Mbit/sec, high speed) or 12 (within the USB 1.1 data transmission of 12 or 1.5 Mbit/sec, middle speed or low speed) presently. Respectively, placard 212 and 213 clearly marked 480 and 12 are filled up the through hole 211 and can be pervious to light. (It should be noted that the above-identical placard structure is only a kind of configuration for showing the mutual transmission of information between a host computer and other peripheral devices presently. A plurality of light-emitting units can be provided to the surface of the housing of the USB hub. The surface of the light-emitting units may be printing marks, e.g. high speed, middle speed and low speed, for users to recognize clearly.)

By this arrangement, the host computer can be connected to the USB port 22 of USB hub 2 via buses and a lack of USB can be expanded for connecting other peripheral devices to the host computer. After other peripheral devices are inserted into the USB port 23, the mutual transmission of information between a host computer and other peripheral devices will be transmitted. When the data is transmitting, the light-emitting unit 21 is then shining and showing the data transmission rate between the host computer and the USB hub 2 is under a high speed, a middle speed or a low speed. With this information, enable users to judge the speed of connected data bus and serve to manage the peripheral devices fitted out with the hub at the end. Also, it can be confirmed whether this USB hub 2 is provided a function of data transmission with varied speed for download data bus or not. This function is able to make the use of bandwidth more effective and reduce improper use of the data bus so as to prevent a jam of data transmission and judge if a USB hub can be worked in a high speed of the USB 2.0 data transmission. By virtue of this device, enable users to judge if the peripheral devices connected by a hub in series and the transmission speed of data between host computers are matching suitably, and a peripheral device with the same transmission rate can be replaced so as to prevent a jam from being occurred during data transmission.

It is not intended, however, that the invention is limited to the particular embodiments described or to use in connection with the apparatus illustrated herein. Various modifications and alternative embodiments such as would ordinarily occur to one skilled in the art to which the invention relates are also contemplated and included within the meaning and range of equivalents of the appended claims.

What is claimed is:

1. A USB (Universal Serial Bus) hub comprising a device for showing the transmission rate of data in its inner part, and the obtained result of the device can be shown via a lamp signal; by virtue of this device, enable users to judge if the peripheral devices connected by a hub in series and the transmission speed of data between host computers are matching suitably or not, and a peripheral device with a same transmission rate can be replaced so as to prevent a jam from being occurred during data transmission.

2. A USB hub as claimed in claim 1, wherein:
the lamp signal is disposed in a through hole on the surface of the USB hub and placards pervious to light and marked 480 and 12 respectively are disposed to opposite a light-emitting unit

3. A USB hub as claimed in claim 1, wherein:
the lamp signal is shown by a plurality of light-emitting units exposed externally to a surface of a housing of an USB hub and printing marks with high speed, middle speed and low speed are opposite to the surface of the light-emitting units for users to recognize clearly.
